(19) United States
(12) Patent Application Publication
(10) Pub. No.: US 2026/0264314 A1
(43) Pub. Date: Sep. 10, 2026

(54) AIR NOZZLE AS WELL AS STRETCHING UNIT COMPRISING AN AIR NOZZLE

(71) Applicant: BRÜCKNER MASCHINENBAU GmbH, Siegsdorf (DE)

(72) Inventors: Anton WETTEMANN, Vachendorf (DE); Andreas LOIDER, Siegsdorf (DE)

(21) Appl. No.: 19/559,103

(22) Filed: Mar. 6, 2026

(30) Foreign Application Priority Data
Mar. 7, 2025 (DE) 10 2025 108 788.1

(51) Int. Cl. B29C 55/02; B05B 1/30

(52) U.S. Cl. CPC B29C 55/02; B05B 1/30

(57) ABSTRACT

An adjustable air nozzle for an oven of a stretching unit including a housing, outlet openings, ducts, and an adjustment device. A storage space is formed within the housing. The ducts each comprise an inlet on their first end that opens into the storage space and open on their second end into the environment of the housing, the oven, by means of the outlet openings. The adjustment device comprises a moveable closure element for changing a flow cross section of the inlets of the ducts, wherein the adjustment device is designed in such a way that the closure element can be moved between different positions, and will result in changing the flow cross section of at least one of the inlets.

### CROSS REFERENCE TO RELATED APPLICATION

This application claims priority to German Patent Application Number DE 10 2025 108 788.1, filed March 7, 2025, the entire contents of which is hereby incorporated by reference.

### FIELD OF DISCLOSURE

The disclosure relates to an air nozzle as well as a stretching unit comprising such an air nozzle.

### BACKGROUND

Stretching units are used in particular in the production of plastics films. Typically, the film to be stretched moves in such units through an oven of the unit in a drawing direction by means of a film transport system. The film to be stretched is heated in the oven before the stretching process and also temperature controlled in, during and after the stretching process. Subsequently, the stretched film is cooled in the oven.

To control the temperature of the oven and the film, nozzle boxes are used that extend in the transverse direction along the film and comprise a plurality of outlet openings that are directed towards the film. Temperature-controlled air is conveyed through the nozzle boxes, said air flowing through the outlet openings towards the film and either heating or cooling this.

Such air nozzles control the temperature of the film and the region of travel of the film along the transverse direction equally. However, this can be problematic as the film cools slower in the external regions of the film in which the film is gripped by the grippers as the grippers have on the one hand a higher thermal mass and cool slower and on the other hand warm air is conveyed out of the oven through the grippers. Bulges, which result in a film that is not flat, form in the external regions of the film as a result of the differing cooling behaviour and the related shrinkage behaviour of the external regions.

### SUMMARY

There is provided an air nozzle and a stretching unit with which particularly flat films can be produced.

There is provided an adjustable air nozzle for an oven of a stretching unit, in particular a transverse direction orienter, a machine direction orienter and/or a simultaneous stretching unit, comprising a housing, multiple outlet openings, multiple ducts and an adjustment device. A storage space is formed within the housing, and the ducts at their first end each have an inlet that opens into the storage space. At their second end, the ducts open by means of the outlet openings into the environment of the housing, in particular into the oven. The adjustment device comprises a moveable closure element for changing a flow cross section of the inlets of the ducts, wherein the adjustment device is designed in such a way that the closure element can be moved between different positions, thereby changing the flow cross section of at least one of the inlets.

As the flow cross section of the inlets of the ducts that feed the outlet openings can be changed by means of the closure element, it is possible to direct flows of air of varying intensity to different sections of the region of travel and film, and thus to control the temperature differentially.

In addition, the adjustment device enables the flow profile to be changed simply, in particular during operation of the stretching unit.

In this way, it is possible to control the temperature of the film optimally, for example cool the external section of the film more strongly in order to obtain a uniform cooling behaviour in the film, thus improving the planarity of the film.

For example, the ducts are separated from each other fluidly.

The closure element is located, for example, in the storage space, in particular completely.

The air nozzle can comprise an air inlet opening that is connected fluidly to the storage space.

In an embodiment, the closure element can be designed to close the inlets of the ducts, in particular wherein the closure element in at least two different positions closes a different number of inlets. In this way, air outlet openings can be deactivated completely, thereby reducing the temperature control of certain sections greatly.

In an embodiment, the closure element has an edge that is arranged at an angle to the direction of travel of the closure element, thereby making it possible to change the flow cross section continuously when moving the closure element.

The angle is greater than 0°, in particular smaller than 20°, wherein the angle opens outwards, i.e. away from the centre. For example, the angle is between 2° and 5°.

For a compact design, the inlets of the ducts can be orientated orthogonally to the outlet openings and/or vertically; and/or the outlet openings can be arranged on the upper side of the housing.

For example, the ducts extend within the housing.

Here, “vertical” is understood to mean perpendicular “in relation to the ground” when the air nozzle is assembled properly.

In an embodiment, at least the outlet openings are arranged in one or more rows, particularly in one or more rows in a first direction, in order to be capable of changing the air flow to the film across a large region.

For example, each outlet opening is assigned to a duct. A duct may have multiple outlet openings.

In an embodiment, the inlets of the ducts are arranged along a first direction in a row, thereby simplifying the adjustment device.

The ducts themselves may also be arranged in a row. The first direction of the rows of ducts and the first direction of the row of outlet openings is identical.

It is also conceivable that the outlet openings are offset in a second direction from each other.

To change to the air flow in the region of travel uniformly, the adjustment device can be designed in such a way that a closing movement of the closure element results in the flow cross sections of the inlets along the row being reduced successively.

The reduction of the flow cross section occurs in sequence, starting from the centre.

The flow cross section of one of the ducts is, for example, always greater or, if the corresponding inlet is completely opened or closed, equal to the flow cross section of another duct that is located further forward in the row, in particular the duct directly in front of it.

The flow cross section can be reduced until the inlet is closed.

In an embodiment, the adjustment device is designed in such a way that the closure element is moved linearly and/or is moved perpendicularly or parallel to the direction of the row, thereby making it possible to move the closure element in a simple manner.

The adjustment device can comprise a holder for the closure element, on which the closure element is suspended, in particular with horizontal play, so that the closure element seals the inlets even better.

The closure element is only held in particular by the holder, for example, on its upper end, thereby enabling the remaining part of the closure element to be freely movable within the range of mobility of the material of the closure element itself.

In an embodiment, the adjustment device comprises an actuator, in particular an electric motor, for the closure element, wherein the adjustment device is designed in such a way that the actuator can move the closure element between the different positions. In this way, it is possible to change the air flow automatically. In particular, the motor is a servo motor.

For example, the adjustment device comprises a mechanism that transmits the rotational movement of the actuator into a linear movement of the closure element and the holder. The mechanism can also support the closure element and the holder.

To be capable of changing the flow cross sections in an even more targeted manner, the inlets can be arranged in the same plane and/or the closure element can be a plate or mat, in particular a metal sheet.

The closure element is in particular a single piece. The closure element has, for example, a thickness of less than 2 mm, for example 0.5 mm and/or is made of spring steel.

For a particularly airtight covering of the inlets, a support surface for the closure element can be arranged adjacent to the inlets, in particular wherein the support surface is formed by a single piece of metal sheet.

For example, the metal sheet for the support surface is attached, in particular adhered, to a collar of the duct.

Moreover, the object is solved by means of a stretching unit, in particular a transverse direction orienter, machine direction orienter and/or simultaneous stretching unit, comprising an oven and at least one adjustable air nozzle as described previously.

The features and advantages described for the air nozzle apply equally to the stretching unit and vice versa.

For example, a region of travel for a film is defined in the oven and said at least one adjustable air nozzle is arranged below or above the region of travel, wherein the outlet openings of said at least one adjustable air nozzle are orientated towards the region of travel.

In particular, multiple adjustable air nozzles are provided as described previously, wherein the adjustable air nozzles are arranged either all below or all above the region of travel. It is also conceivable that one or more of the adjustable air nozzles are arranged below the region of travel and one or more of the adjustable air nozzles are arranged above the region of travel.

It is conceivable that the adjustable air nozzles are arranged in the direction of travel in pairs, wherein the adjustable air nozzles of a pair are adjacent to each other in the centre or have in the centre a spacing from each other.

For example, the stretching unit has a compressor that is designed to convey air to the air inlet opening or into the storage space.

In an embodiment, the first direction is perpendicular to a direction of travel of the film in the region of travel, wherein the adjustment device is designed in such a way that the ducts closer to the centre are initially closed during a closing movement of the closure element. In this way, the edge regions can be temperature controlled more greatly.

The air nozzle extends, for example, from the outside perpendicular to the direction of travel below or above the region of travel towards the centre.

In an embodiment, the stretching unit comprises a transport system for the film, wherein the film transport system comprises two film transport rails that are moveable perpendicular to the direction of travel, wherein said one or said multiple adjustable air nozzles are designed moveably together with one of the film transport rails. In this way, it is ensured that the region at the transport rails is always temperature controlled.

### BRIEF DESCRIPTION OF THE DRAWINGS

Additional features and advantages of the disclosure are found in the following description as well as the attached drawings to which reference is made.

FIG. 1 shows a schematic view of a stretching unit according to an embodiment of the disclosure comprising an adjustable air nozzle according to an embodiment of the disclosure.

FIGS. 2 and 3 show sections through one of the adjustable air nozzles along the transverse direction and the direction of travel of the stretching unit according to FIG. 1.

FIG. 4 shows a schematic enlargement of FIG. 3 around an inlet.

FIGS. 5 and 6 show a simplified enlarged section of FIG. 2 in different positions of the closure element.

FIG. 7 shows a section of FIG. 1 comprising marked flow profiles.

FIGS. 8 and 9 show sectional views corresponding to those in FIGS. 2 and 3 of a second embodiment of an adjustable air nozzle, and

FIGS. 10(a), 10(b), and 10(c) show sections according to those in FIG. 3 of exemplary embodiments of an adjustable air nozzle according to the disclosure.

### DETAILED DESCRIPTION

Lists having a plurality of alternatives connected by “and/or”, for example “A, B and/or C” are to be understood to disclose an arbitrary combination of the alternatives, i.e. the lists are to be read as “A and/or B and/or C” or as "at least one of A, B or C". The same holds true for listings with more than three items.

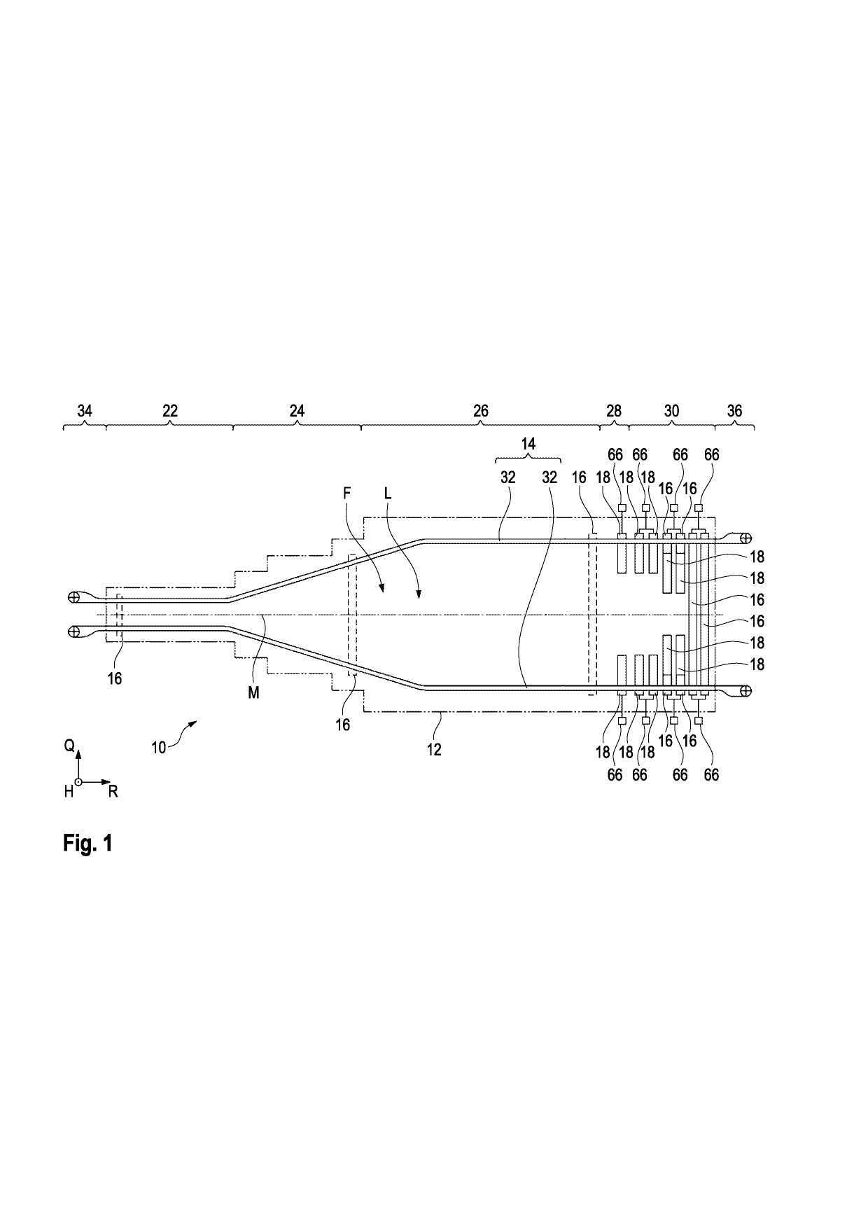

In FIG. 1, a stretching unit 10 according to the disclosure is shown extremely schematically.

In the shown first embodiment, the stretching unit 10 is termed a transverse direction orienter (also TDO). It is also conceivable that the stretching unit is a machine direction orienter or a simultaneous stretching unit.

The stretching unit 10 comprises an oven 12, a film transport system 14, static air nozzles 16 and at least one adjustable air nozzle 18.

The oven 12 has a direction of travel R which corresponds to the direction of movement of the film F to be stretched. The transverse direction Q of the oven 12 runs transversely to the direction of travel R and horizontally; the vertical direction H runs vertically.

Along the direction of travel R, the oven 12 has different zones for treating the film F to be stretched.

The film F is heated in the first zone, the preheating zone 22. In the subsequent second zone, the stretching zone 24, the film F is stretched in the transverse direction Q so that its width is greater at the end of the stretching zone 24 than it was at the start.

After completing the stretching, the film F passes through a third zone, an annealing zone 26 (also termed “heat treatment zone” or “further heating zone”), in which a relaxation of the film F can take place at high temperatures.

Subsequently, the film F passes through a fourth zone, a neutral zone 28, and a fifth zone, a cooling zone 30, wherein the film F is cooled in the cooling zone 30. The neutral zone 28 is used to separate the annealing zone 26 and the cooling zone 30.

The film transport system 14 comprises two film transport rails 32 in the known manner, which are arranged relative to a middle plane M of the stretching unit 10 or the oven 12 at a spacing and which extend at least in part into the oven 12.

The film transport rails 32 run outside of the oven 12 in an entry zone 34 and an exit zone 36, in said zones the film F of the stretching unit 10 is fed and removed.

The film F is gripped in the known manner by grippers (not shown) of the film transport system 14 which are guided along the film transport rails 32 and is transported through the oven 12 in the direction of travel R.

In this way, a region of travel L is defined in the oven 12 by the film transport rails 32, in said region of travel L the film F is transported through the oven 12. The width of the region of travel L in the transverse direction Q is as wide as the film F, and the centre of the region of travel L in the transverse direction Q corresponds to the centre M.

The film F is drawn through the oven 12, for example, at high speeds, for example at speeds between 50 and 1,000 m/min.

To temperature control the oven 12 and the film F, the static air nozzles 16 and the adjustable air nozzles 18 are used, which each extend in the transverse direction Q and are arranged one after another in the direction of travel L. The static air nozzles 16 and the adjustable air nozzles 18 each have a plurality of outlet openings that are orientated towards the film F. Temperature-controlled air is conveyed by the static air nozzles 16 and the adjustable air nozzles 18, said air flowing through the outlet openings towards the film F to heat or cool this.

The static air nozzles 16 are arranged, for example, in the preheating zone 22, the stretching zone 24, the annealing zone 26 and in part also in the cooling zone 30. In FIG. 1, only one of the static air nozzles 16 of the preheating zone 22, the stretching zone 24 and the annealing zone 26 are indicated as dashed lines for the sake of clarity. The static air nozzles 16 are arranged above and below the region of travel L.

The static air nozzles 16 are constructed as known from the prior art. In particular, air is supplied across the entire width of film F by means of the static air nozzles 16.

In contrast, the adjustable air nozzles 18 are adjustable in this respect so that the air flow is adjustable from different outlet openings 38 of the same adjustable air nozzle 18.

The adjustable air nozzles 18 are arranged, for example, as in the shown embodiment, in the neutral zone 28 and/or the cooling zone 30, in particular at the end of the neutral zone 28 and/or at the start of the cooling zone 30.

The adjustable air nozzles 18 are located either all above or all below the region of travel L. It is also conceivable that one or more of the adjustable air nozzles 18 are arranged below the region of travel L and one or more of the adjustable air nozzles 18 are arranged above.

The outlet openings 38 of the adjustable air nozzles 18 are also orientated towards the region of travel L.

The adjustable air nozzles 18 extend from outside in the transverse direction Q towards the centre. For example, the adjustable air nozzles 18 are arranged in the direction of travel L in pairs, wherein the adjustable air nozzles 18 of a pair are adjacent to each other in the centre M or have in the centre a spacing from each other.

Said one, multiple or all of the adjustable air nozzles 18 can be designed moveably, for example, together with one of the film transport rails 32.

Hereinafter, one of the adjustable air nozzles 18 is described in more detail, wherein within the scope of this disclosure reference is merely made to the “air nozzle” instead of the “adjustable air nozzle” for the sake of simplicity. The static air nozzles already known are always termed “static air nozzles” to prevent any confusion.

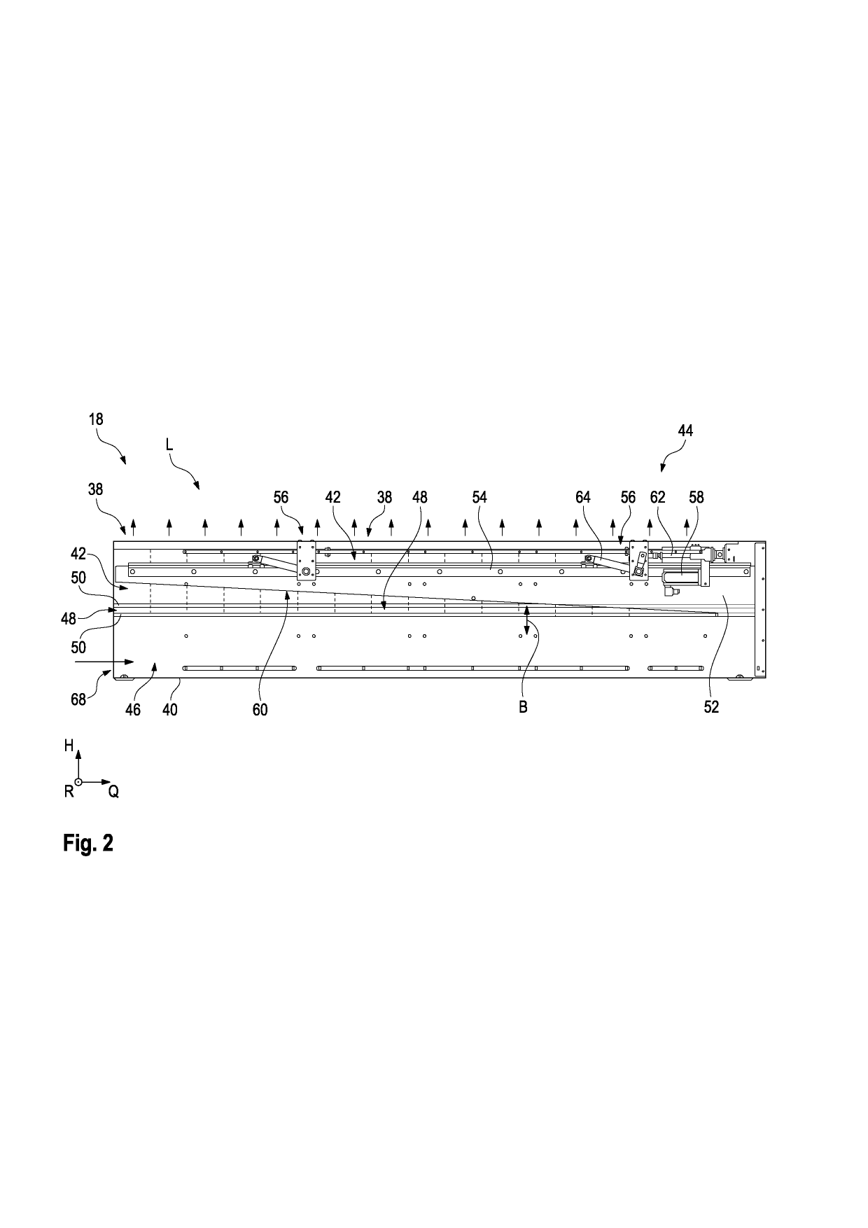

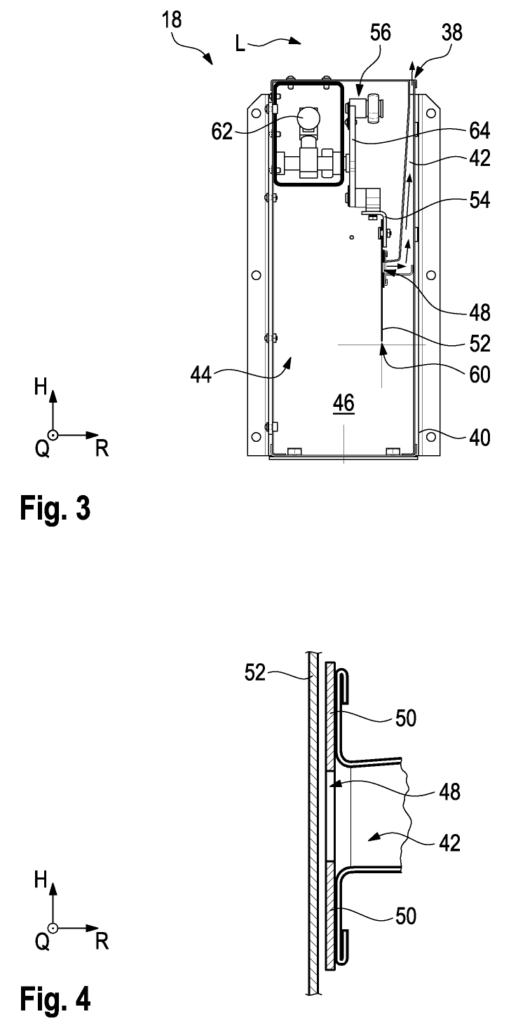

The FIGS. 2 and 3 show one of the air nozzles 18 in a section along the transverse direction Q and along the direction of travel R.

In addition to the outlet openings 38, the air nozzle 18 comprises a housing 40, multiple ducts 42 as well as an adjustment device 44.

The housing 40, is designed rectangularly, for example, as shown in FIGS. 2 and 3, and has an upper side (the side facing upwards in FIGS. 2 and 3) in which the outlet openings 38 are provided.

The length of the housing 40 in the transverse direction Q of the stretching unit 10 is, for example, between 2 m and 4 m, in particular 2.4 m.

The outlet openings 38 are arranged in a row that extends in a first direction. This first direction corresponds, for example, to the transverse direction Q of the stretching unit 10 (cf. FIG. 4).

The housing 40 is designed hollowly so that a storage space 46 is formed within the housing 40. In addition, the ducts 42 run, for example, within the housing 40.

For example, a duct 42 is allocated to each of the outlet openings 38, through said duct 42 the air is conveyed from the interior of the housing 40 to the outlet opening 38.

The ducts 42 are arranged in a row next to each other like the outlet openings 38 in the first direction.

The ducts 42 and one or more of its walls are formed, for example, by means of metal sheets that extend continuously in the first direction and are attached to the housing 40. A wall of the housing 40 can even form a wall of the ducts 42.

The ducts 42 are separated from each other fluidly so that each of the outlet openings 38 are also only connected fluidly to one of the inlets 48.

Webs can be provided to separate the ducts 42.

Accordingly, the inlets 48 are also arranged in a row in the first direction and are, for example, all within the same planes.

The opening of the duct at the first end and thus also the inlet 48 is orientated orthogonally to the outlet opening 38 of the duct 42. The air thus flows horizontally into the duct 42. The information “vertical” and “horizontal” are in relation here to the ground when the air nozzle 18 is assembled properly (as shown in FIGS. 2 and 3).

The ducts 42 are designed in particular identically so that only one of the ducts 42 is described hereinafter.

As can be seen clearly in FIG. 3, the duct 42 has a first end and a second end.

The second end of the duct 42 is open towards the environment of the housing 40, thus towards the oven 42, and can constitute the outlet opening 38 of the duct 42.

The first end of the duct 42 opens into the storage space and thus forms an inlet 48 of the duct 42.

The inlet 48 is designed spaced apart from the upper side of the housing 40 in the vertical direction H. For example, the spacing is greater than a quarter, in particular greater than a third of the height of the housing 40.

The duct 42 runs, for example, starting from its first end initially horizontally and subsequently vertically upwards. As in the shown embodiment, the duct can taper in the vertically upward section towards the outlet opening 38.

The cross section of the duct 42 is thus a L-shape.

A support surface 50 is arranged adjoining the inlet 48 at the top and bottom, for example, as shown in FIG. 4. The support surface 50 is, for example, a component that is separate from the walls of the duct 42 and is attached to, for example adhered to, a collar at the first end of the duct 42.

The support surface 50 is formed as a single piece, for example, for the inlets 48 of all ducts, for example by a single piece of sheet metal that extends in the first direction and in which openings corresponding to the inlets 48 are formed. It is conceivable that the metal sheet comprises vertical webs over the inlets 48, thereby increasing the stability.

The adjustment device 44 comprises a moveable closure element 52, a holder 54, a drive device 56 as well as an actuator 58.

For example, the adjustment device 44 is located entirely within in the housing 40. However, it is also conceivable that individual parts may be arranged outside of the housing 40, in particular the actuator 58 and parts of the drive device 56.

However, the closure element 52 is located in particular within in the housing 40.

The closure element 52 is designed planarly, for example a mat or a plate. In the shown embodiment, the closure element 52 is a metal sheet.

The closure element 52 can be a metal sheet with a thickness of less than 2 mm, for example with a thickness of 0.5 mm, and is made of spring steel.

Other materials for the closure element 52 are also conceivable.

As seen in FIG. 2, the closure element 52 extends in the vertical direction H as well as in the first direction and transverse direction Q along all ducts 42. The closure element 52 is thus formed as a single piece for all ducts 42 in the shown embodiment.

It is also conceivable that the closure element is not designed as a single piece so that parts of the closure element are provided for only one or several of the ducts 42 and other parts of the closure element for other ducts 42.

The closure element 52 is held by the holder 54 at a plane that is parallel to the plane of the inlets 48 and extends directly in front of the inlets 48. For example, the plane, in which the closure element is located, is limited on one side by the support surface 50 of the ducts 42.

For example, the attachment of the closure element 52 occurs in the holder 54 with horizontal play so that only movements under 5 mm are allowed.

The closure element 52 is suspended, for example, using its upper edge on the holder 54 and the remaining part is without any attachment so that the closure element 52, in particular the lower edge of the closure element 52, is moveable.

As seen in FIG. 2, the lower edge of the closure element 52 is not horizontal, but runs at an angle other than 0° to the transverse direction Q and the vertical direction H. The angle is, for example, between 2° and 5°, but a maximum of 20°.

Here, the lower edge 60 is towards the centre M lower than the external end of the air nozzle 18.

For example, the lower edge 60 inclines continuously. It is however also conceivable that the lower edge 60 has one or more levels.

The holder 54 is attached to the drive device 56 that in turn is connected to the actuator 58.

The actuator 58 is, for example, an electric motor, such as servo motor.

The drive device 56 comprises a screw drive 62 as well as one, two or more lever systems 64. The screw drive 62 is connected on one side to the actuator 58 as well as on the other side to at least one of the lever systems 64.

The holder 54 is attached in turn to the lever system 64. The drive device 56 supports, for example, the holder 54 and the closure element 52 completely.

It is also conceivable that the drive unit, thus the drive device 56 and the actuator 58, are designed as a pneumatic or hydraulic drive unit.

The holder 54 and thus the closure element 52 can be moved, for example, linearly by means of the actuator 58 and the drive device 56.

The movement occurs, for example, as shown in the first embodiment, in a direction of travel B that in the first embodiment is perpendicular to the first direction and thus vertical.

The closure element 52 can thus be put into different positions by means of the actuator 58, wherein a downwards movement corresponds to a closing movement, and an upwards movement corresponds to an opening movement.

In the case of the closing movement, the ducts 42 and the inlets 48 closer to the centre M are closed initially.

During the operation of the air nozzle, air is introduced into the storage space 46 of the housing 40.

To this end, the stretching unit 10 comprises one or more compressors 66 that take air from the environment of the stretching unit 10 and introduce it via an air inlet opening 68 of the air nozzle 18 into the storage space 46.

The air inlet opening 68 can be provided here on the end face of the housing 40 facing away from the centre M.

In this way, overpressure is generated in the storage space 46 so that air flows from the storage space 46 through the inlets 48 into the ducts 42 and exits out of the outlet openings 38.

Here, air from the storage space 46 can only flow into the inlets 48 to the extent that they are not closed by the closure element 52. Within the scope of this disclosure, this resulting opening is referred to as the flow cross section of the corresponding inlet 48.

The size of the flow cross section of the inlet determines the amount of air that flows out of the outlet opening 38 of the duct 42 into the region of travel L.

If the lower edge 60 of the closure element 52 is below an inlet 48 of one the ducts 42, the closure element 52 rests on the support surface 50 and thus closes the inlet 48.

The overpressure in the storage space 46 results in the closure element 52 being pressed against the support surface 50, thereby sealing the inlet 48 particularly tightly.

If the lower edge 60 of the closure element 52 is below the inlet 48 across the entire length of the inlet 48 in the first direction, the inlet 48 is completely closed. The corresponding outlet opening 38 is thus inactive and air does not flow at this point out of the housing 40 and the air nozzle 18.

However, if the lower edge 60 of the closing element 52 is completely above the inlet 48, the inlet 48 is thus completely open, and the entire flow cross section of the inlet 48 is available. The air thus flows through the entire flow cross section into the duct 42 and out of the corresponding outlet opening 38. The outlet opening 38 is thus active.

It is also conceivable that the closure element 52 only covers part of the inlet 48 when the lower edge 60 is in the region of the inlet 48. In this case, the flow cross section of the inlet 48 is reduced so that correspondingly less air flows through the corresponding duct 42 and the outlet opening 38.

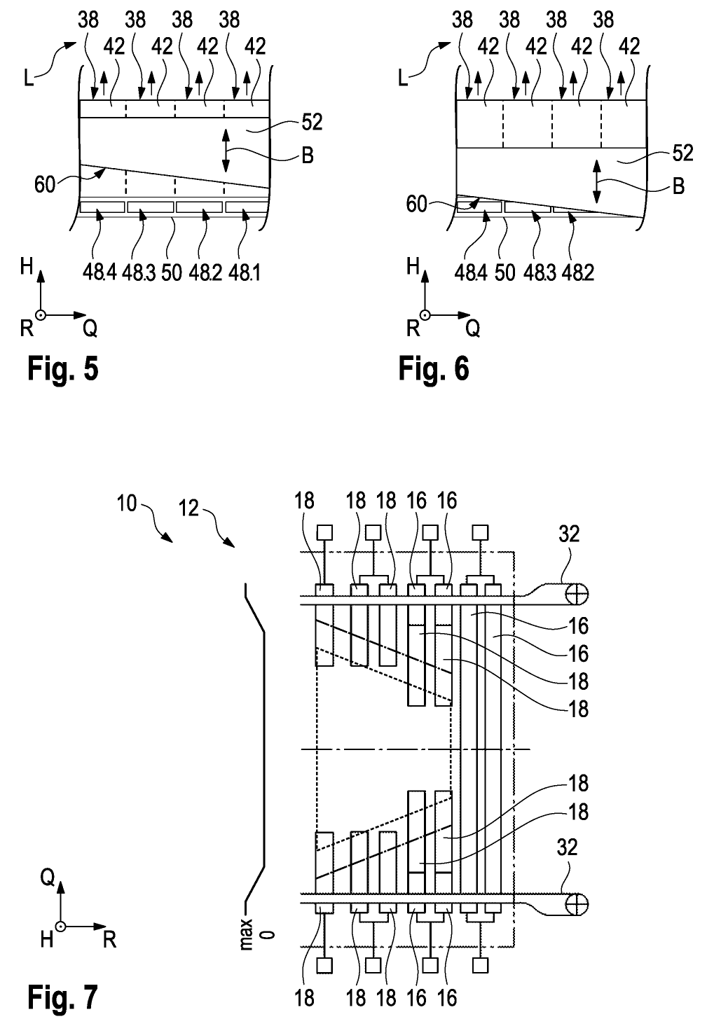

This functional principle is shown schematically and in a simplified manner using FIGS. 5 and 6 which show a section from FIG. 2 in different positions of the closure element 52. In the position shown in FIG. 5, the closure element 52 is located above all shown inlets 48 so that all the inlets 48 shown in FIG. 5 are completely open. All corresponding outlet openings 38 are thus active.

In FIG. 6, however, the closure element 52 has been shifted by a closing movement into a second position, in which the lower edge 60 of the closure element 52 is now below the inlet 48.1 that is closest to the centre M in FIG. 6 (i.e. the right inlet 48). This inlet 48.1 is thus completely closed and the corresponding outlet opening 38 is inactive. The next inlet 48.2 in the row (second from the right in FIG. 6), which in turn is adjacent to inlet 48.1, is not completely closed by the closure element 52 as the lower edge 60 at the end facing away from the centre M (left end) is not below the inlet 48.2. The flow cross section of this inlet 48.2 is however considerably reduced so that the air flow is low through the corresponding outlet opening 38.

The next inlet 48.3 of the row of inlets (third inlet from the right), which is adjacent to inlet 48.2, is also in part closed by the closure element 52 so that the flow cross section of this inlet 48.3 is also lower than that of a completely opened inlet 48. The flow cross section of the inlet 48.3 is however larger than the flow cross section of inlet 48.2 which is more closed and further towards the centre M.

In particular, the flow cross section of the inlet 48.3 is larger than the flow cross section of all of the ducts 42 that are further towards the centre M, such as inlets 48.1 and 48.2.

This continues as the flow cross section of the inlet 48.4, which is directly adjacent to the inlet 48.3, but further away from the centre M, is larger than that of the inlet 48.3. The closing movement from the position in FIG. 5 to the position in FIG. 6 has thus resulted in reducing the flow cross sections of the inlets 48 successively along the row.

If the closing movement is continued, i.e. the closure element 52 moves further downwards, the flow cross sections of inlets 48.2, 48.3 and 48.4 are reduced further until they are finally completely closed, like inlet 48.1.

In particular, the flow cross sections of adjacent inlets 48 are only the same in the completely open and completely closed states. Consequently, a different number of inlets 48 can be closed by the closure element 52 in different positions and, moreover, the flow cross sections of the inlets 48 can be reduced, thereby making the air nozzle 18, or rather the air flow out of the air nozzle 18, adjustable.

FIG. 7 shows the arrangement of the adjustable air nozzles 18 and the static air nozzles 16 at the end of the neutral zone 28 and the cooling zone 30 enlarged again.

Here, the air nozzles 18 of the first pair of air nozzles 18 are in the neutral zone, followed by two further pairs of adjustable air nozzles 18.

The two further pairs of adjustable air nozzles 18 downstream in the direction of travel R are offset towards the centre M, wherein a static air nozzle 16 is provided in each case on their outer sides. This combination of an adjustable air nozzle 18 and a static air nozzle 16 can be regarded as a shared air nozzle, in which the air flow is adjustable only via a part of the expansion of the air nozzle.

Two static air nozzles 16, as known from the prior art, are provided downstream of both of these pairs of air nozzles. It is also conceivable that the cooling zone 30 is longer and that further static air nozzles 16 follow.

In FIG. 7, a region about the centre M is shown with dotted lines, in which no air is blown into the region of travel L or against the film F as there are either no air nozzles 16, 18 present in this region or adjustable air nozzle 18 are present which are set however in such a way that the outlet openings 38 in this region are inactive.

Outside this region, air is blown into the region of travel L and against the film F, wherein the corresponding air flow in the region of travel L or against the film F increases with increasing distance from the centre M. The dash-dotted line marks the line at which the air flow in the region of travel L corresponds to half of the maximum air flow.

In this way, a flow profile is generated in the transverse direction Q as is shown in the graph on the left side in FIG. 7, wherein the graph illustrates the flow profile of the first air nozzle 18.

Continuing in the direction of travel R, the graph shifts inwards.

In this way, it is attained that air is blown on the outer section of the region of travel L more strongly and, for example, can be cooled more. As a result, the film that - as described - requires more cooling in the outer regions (in particular in the region of the grippers) can be cooled more rapidly in these outer sections. Consequently, the planarity of manufactured film F is increased.

As the air flow can be adjusted by the adjustable air nozzles 18 during operation, the manufacture of high-quality film is possible under different and also changing conditions.

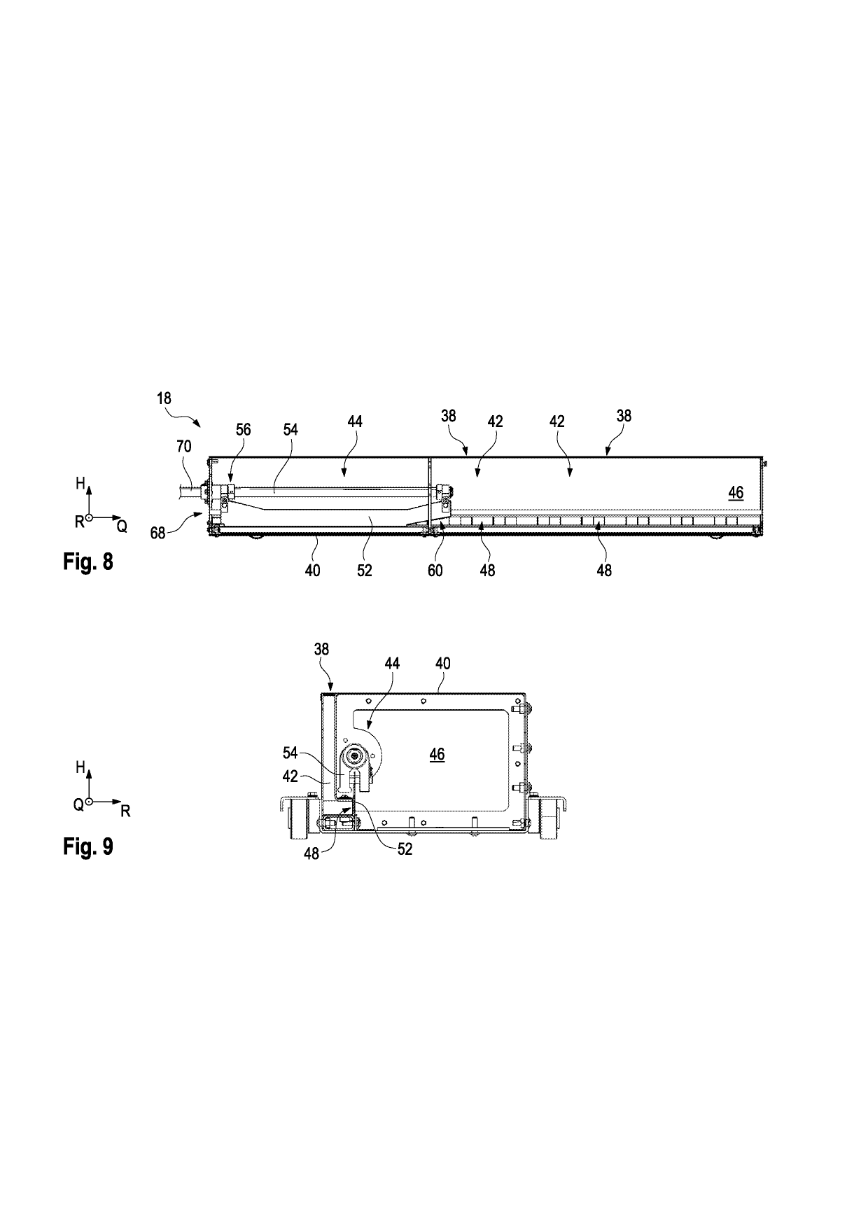

FIGS. 8 to 10(a)-(c) show further embodiments of an adjustable air nozzle 18 that correspond substantially to the first embodiment so that only the differences are discussed hereinafter. Identical and functionally equivalent parts are provided with the same reference signs.

FIGS. 8 and 9 show views corresponding to those in FIGS. 2 and 3 of a second embodiment of an adjustable air nozzle 18.

In contrast to the first embodiment, the closure element 52 is not moved perpendicularly to the first direction of rows of outlet openings 38 and inlets 48, but rather parallel to these.

In the shown embodiment, the direction of travel thus corresponds to the transverse direction Q of the stretching unit 10.

The movement of the closure element 52 can occur manually by means of a bar 70 extending out of the housing 40.

It is also conceivable that the closure element 52 is actuated by means of an actuator.

Even in this second embodiment, the lower edge 60 of the closure element 52 is angled so that a continuous increase in air flow can be generated from the outlet openings 38. Only a section of the lower edge 60 is angled in order to generate a transition section.

Inlets 48 before the transition section (i.e. with regard to FIG. 8, right of the transition section) are completely open, and inlets 48 after the transition section are completely closed.

The sections before and/or after the transition section run, for example, horizontally. For example, as in the shown embodiment, the greater part of the lower edge 60 of the closure element 52 runs horizontally.

As can be seen in FIG. 9, the inlets 48 are located in the bottom third of the housing 40 because as a result of the horizontal movement of the closure element 52 it is not necessary to provide a region for receiving the closure element 52 below the inlets 48.

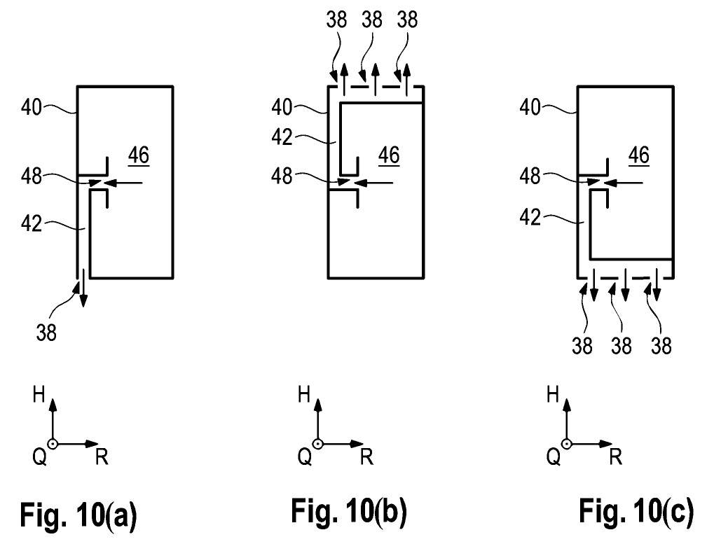

The FIGS. 10(a), 10(b), and 10(c) show greatly simplified cross sections of further embodiments according to those of FIGS. 3 and 9.

In FIG. 10(a), a third embodiment of an air nozzle 18 is shown that differs from the first embodiment in that the outlet openings 38 are located on the underside of the housing 40. Such an air nozzle 18 is thus suited for being arranged above the region of travel L.

Just like in the first embodiment, the holder 54 and the drive device 56 can be located above the inlets 48.

In FIG. 10b, a fourth embodiment is shown that substantially corresponds to the first embodiment.

In contrast to the first embodiment, multiple rows of outlet openings 38 are provided, namely three rows, which are offset from each other in a second direction. Accordingly, the outlet openings 38 are also offset from each other in a second direction.

The second direction is for example the direction of travel R.

As can be seen in FIG. 10(b), outlet openings 39 of multiple rows are provided on the second end of a duct 42, thus are fed by means of the same inlet 48. Thus, each outlet opening 38 is still allocated to a duct 42, however a duct 42 now has multiple outlet openings 38. In this way, the width of the air flow is increased in the direction of travel R.

In FIG. 10(c), a fifth embodiment is shown that corresponds to the fourth embodiment of FIG. 10(b), wherein the outlet openings 38 are located on the underside of the housing 40, similar to the third embodiment according to FIG. 10(a).

1. An adjustable air nozzle for an oven of a stretching unit, comprising:
a housing, multiple outlet openings, multiple ducts and an adjustment device,
wherein a storage space is formed within the housing,
wherein each duct comprises an inlet on their first end that opens into the storage space, and the ducts open on their second end into the environment of the housing by means of the outlet openings, and
wherein the adjustment device comprises a moveable closure element for changing a flow cross section of the inlets of the ducts, wherein the adjustment device is designed in such a way that the closure element is moveable between different positions, thereby changing the flow cross section of at least one of the inlets.

2. The adjustable air nozzle according to claim 1, wherein the ducts open on their second end into the oven.

3. The adjustable air nozzle according to claim 1, wherein the closure element is configured to close the inlets of the ducts.

4. The adjustable air nozzle according to claim 3, wherein the closure element closes a different number of inlets in at least two different positions.

5. The adjustable air nozzle according to claim 1, wherein the closure element comprises an edge that is arranged at an angle to the direction of travel of the closure element.

6. The adjustable air nozzle according to claim 1, wherein at least one of the inlets of the ducts are orientated at least one of orthogonally to the outlet openings or vertically; or the outlet openings are arranged on the upper side of the housing.

7. The adjustable air nozzle according to claim 1, wherein at least the outlet openings are arranged in one or multiple rows or in one or multiple rows in a first direction.

8. The adjustable air nozzle according to claim 1, wherein the inlets of the ducts are arranged in a row along a first direction.

9. The adjustable air nozzle according to claim 8, wherein the adjustment device is designed in such a way that a closure movement of the closure element results in the flow cross sections of the inlets being reduced successively along the row.

10. The adjustable air nozzle according to claim 9, wherein adjustment device is configured in such a way that the closure element is at least one of moved linearly or moved perpendicularly or parallel to the direction of the row.

11. The adjustable air nozzle according to claim 1, wherein the adjustment device comprises a holder for the closure element, on which the closure element is suspended.

12. The adjustable air nozzle according to claim 11, wherein the closure element is suspended with horizontal play.

13. The adjustable air nozzle according to claim 1, wherein the adjustment device comprises an actuator for the closure element, wherein the adjustment device is designed in such a way that the actuator is configured to move the closure element between different positions.

14. The adjustable air nozzle according to claim 1, wherein at least one of the inlets are arranged in the same plane; or the closure element is a plate or mat or a metal sheet.

15. The adjustable air nozzle according to claim 1, wherein a support surface for the closure element is arranged adjacent to the inlets.

16. The adjustable air nozzle according to claim 15, wherein the support surface is formed by a single piece of metal sheet.

17. A stretching unit, comprising:
an oven and at least one adjustable air nozzle, wherein the adjustable air nozzle comprises a housing, multiple outlet openings, multiple ducts and an adjustment device,
wherein a storage space is formed within the housing,
wherein the ducts each comprise an inlet on their first end that opens into the storage space, and the ducts open on their second end into the environment of the housing by means of the outlet openings.
wherein the adjustment device comprises a moveable closure element for changing a flow cross section of the inlets of the ducts, wherein the adjustment device is designed in such a way that the closure element is moveable between different positions, thereby changing the flow cross section of at least one of the inlets.

18. The stretching unit according to claim 17, wherein a region of travel for a film is defined in the oven, and said at least one adjustable air nozzle is arranged below or above the region of travel wherein the outlet openings of said at least one adjustable air nozzle are orientated towards the region of travel.

19. The stretching unit according to claim 17, wherein at least one of the first direction is perpendicular to a direction of travel of the film in the region of travel, wherein the adjustment device is designed in such a way that initially the ducts closer to the centre are closed during a closing movement of the closure element; or
that the stretching unit comprises a film transport system, wherein the film transport system comprises two film transport rails that are moveable perpendicular to the direction of travel, wherein said one or said multiple adjustable air nozzles are designed moveably together with one of the film transport rails.

20. The stretching unit according to claim 17, wherein the stretching unit is at least one of a transverse direction orienter, a machine direction orienter or a simultaneous stretching unit.
